(19) United States
(12) Patent Application Publication
(10) Pub. No.: US 2021/0198846 A1
(43) Pub. Date: Jul. 1, 2021

(54) PRINTING DEVICE AND INK EJECTION DEVICE

(71) Applicant: KYOCERA Document Solutions Inc., Osaka (JP)

(72) Inventors: Masaaki MARUTA, Osaka (JP); Masato USUI, Osaka (JP)

(73) Assignee: KYOCERA Document Solutions Inc., Osaka (JP)

(21) Appl. No.: 17/058,051

(22) PCT Filed: Apr. 18, 2019
(86) PCT No.: PCT/JP2019/016585

§ 371 Date: Nov. 23, 2020

(30) Foreign Application Priority Data
May 28, 2018 (JP) 2018-101602

(51) Int. Cl. D06P 5/30; B41F 15/08; B41J 2/21; B41J 3/407; D06P 5/24

(52) U.S. Cl. CPC D06P 5/30; B41F 15/08; D06P 5/003; B41J 3/4078; B41J 2/2114

(57) ABSTRACT

A printing device (100) is provided with: a conveyance device (3) that performs a conveyance operation in which a feeding operation to feed a recording medium (7) and suspension of the feeding operation are repeated; a plate device (2); and an ink ejection device (1). The ink ejection device (1) performs a scan to move a head (8) when the feeding operation is suspended. The conveyance device (3) performs the feeding operation once each time one scan is completed, and is configured to change the amount by which the recording medium (7) is fed by one feeding operation.

### TECHNICAL FIELD

The present invention relates to a printing device and an ink ejection device which perform printing on a recording medium.

### BACKGROUND ART

In the related art, printing may be performed on a fabric material as a recording medium. When printing is performed on a fabric material, ink is applied to the fabric material. After being applied to the fabric material, the ink is fixed thereto.

Here, in printing on a fabric material, an inkjet printer may be used. A technique for printing on a fabric material by using an inkjet printing device is disclosed in, for example, Patent Document 1 identified below.

### CITATION LIST

### Patent Documents

Patent Document 1: Japanese Translation of PCT International Application Published as No. 2007-525339

### SUMMARY OF THE INVENTION

### Technical Problem

In printing on a fabric material, using an inkjet printing device is more advantageous than using a plate, because an inkjet printing device facilitates printing of a detailed image. Moreover, even to print an image in many colors, there is no need of preparing a large number of plates.

On the other hand, inkjet printing devices also have disadvantages as follows: An inkjet printing device prints an image on a fabric material by spraying fine ink droplets (liquid droplets) onto the fabric material. Thus, it tends to be difficult to achieve a desired density with the inkjet printing device. On the other hand, color unevenness may be caused in what should be even-density printing (printing of a solid image) in a certain area.

The present invention has been made to solve the above disadvantages, and an object thereof is to provide a printing device and an ink ejection device capable of printing a high-density image on a recording medium such as a fabric material, with high image quality and no color unevenness.

### Solution to Problem

To achieve the above object, according to a first aspect of the present invention, a printing device includes a conveyance device which conveys a recording medium by performing a conveyance operation in which a feeding operation to feed the recording medium and suspension of the feeding operation are repeated, a plate device which performs printing on the recording medium by using a plate, and an ink ejection device which performs printing on the recording medium by ejecting ink onto the recording medium. Here, the ink ejection device includes a head having a nozzle array including a plurality of nozzles arranged along a Y-axis direction parallel to a conveyance direction in which the recording medium is conveyed, an X-axis moving mechanism which moves the head in an X-axis direction orthogonal to the Y-axis direction on a horizontal plane, and a control portion which, when the feeding operation is suspended, performs scanning by controlling the X-axis moving mechanism to move the head in the X-axis direction, and which makes the head eject ink during the scanning. The conveyance device performs the feeding operation once each time one event of the scanning is completed. The conveyance device is configured to be able to change a feeding amount by which to feed the recording medium in one event of the feeding operation.

According to a second aspect of the present invention, an ink ejection device ejects ink onto the recording medium conveyed by the conveyance device of the printing device according to claim 1, and the ink ejection device includes a head having a nozzle array including a plurality of nozzles arranged along a Y-axis direction parallel to a conveyance direction in which the recording medium is conveyed, an X-axis moving mechanism which moves the head in an X-axis direction orthogonal to the Y-axis direction on a horizontal plane, and a control portion which, when the feeding operation is suspended, controls the X-axis moving mechanism to perform scanning in which the head is moved in the X-axis direction, and makes the head eject ink during the scanning.

### Advantageous Effects of Invention

With a configuration of the present invention, it is possible to print a high-density image on a recording medium such as a fabric material, with high image quality and no color unevenness.

### BRIEF DESCRIPTION OF THE DRAWINGS

FIG. 1 is a diagram showing a printing device according to an embodiment;

FIG. 2 is a diagram showing the printing device according to the embodiment;

FIG. 3 is a diagram showing the printing device according to the embodiment;

FIG. 4 is a diagram showing an ink ejection device according to the embodiment;

FIG. 5 is a diagram showing a head of the ink ejection device according to the embodiment;

FIG. 6 is a diagram showing the head of the ink ejection device according to the embodiment;

FIG. 7 is a diagram showing a moving mechanism of the ink ejection device according to the embodiment;

FIG. 8 is a diagram for illustrating print data which is input to the ink ejection device according to the embodiment;

FIG. 9 is a diagram for illustrating a feeding amount by which to feed a fabric conveyed by the printing device according to the embodiment;

FIG. 10 is a diagram for illustrating definition data stored in the ink ejection device according to the embodiment;

FIG. 11 is a diagram showing an example of an image-type selection screen displayed on an operation panel of the ink ejection device according to the embodiment;

FIG. 12 is a diagram showing an example of a smoothness-level selection screen displayed on the operation panel of the ink ejection device according to the embodiment;

FIG. 13 is a diagram for illustrating how movement of the head in a Z-axis direction is controlled by the ink ejection device according to the embodiment; and

FIG. 14 is a diagram for illustrating ink ejection amount data stored in the ink ejection device according to the embodiment.

### DESCRIPTION OF EMBODIMENTS

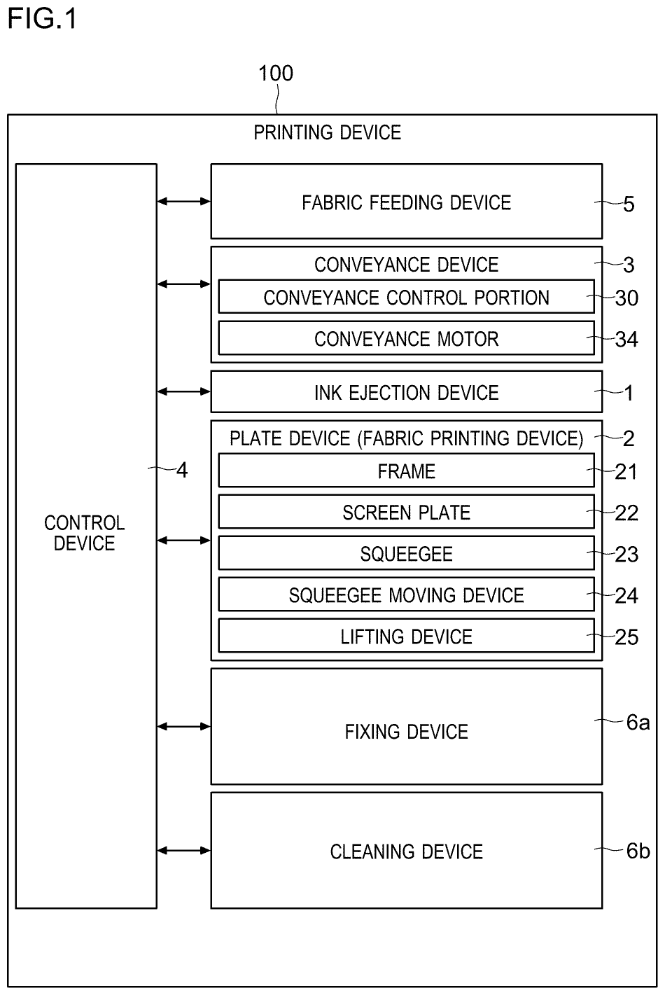

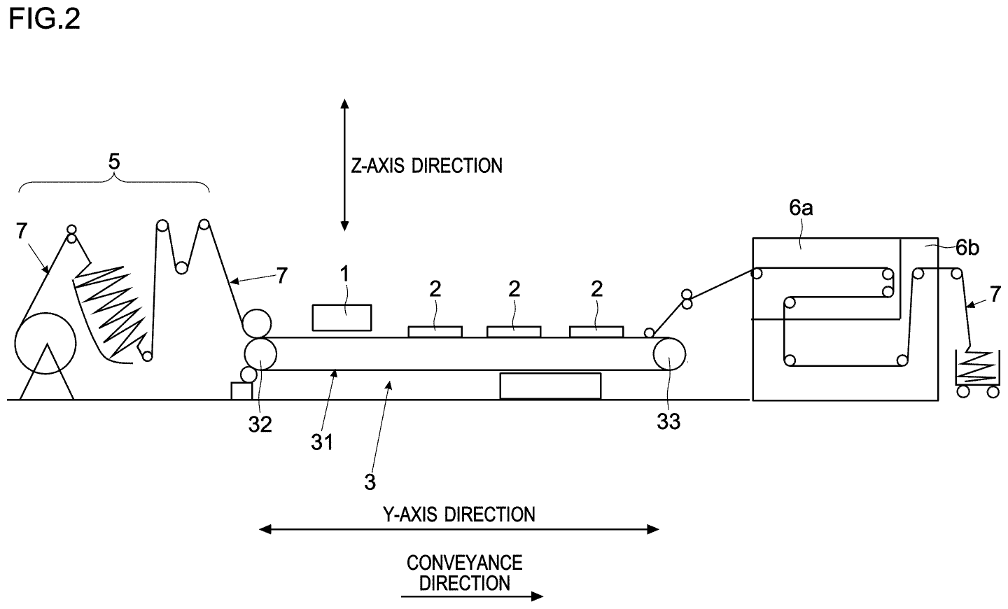

Hereinafter, with reference to FIG. 1 to FIG. 14, a description will be given of an ink ejection device 1 according to the present embodiment and a printing device 100 including the ink ejection device 1. Here, the printing device 100 includes a plate device 2. The plate device 2 is a fabric printing device. The ink ejection device 1 and the plate device 2 perform printing on a recording medium.

In the following description, a fabric 7 is used as a recording medium, but there is no particular limitation to the type of the recording medium. Materials usable for printing both with the ink ejection device 1 and with the plate device 2 may be employed as a recording medium. For example, the recording medium may be paper.

In the following description, a direction parallel to a conveyance direction of the fabric 7 will be referred to as a Y-axis direction. A direction that is orthogonal to the Y-axis direction on a horizontal plane will be referred to as an X-axis direction. A direction that is orthogonal to both the Y-axis direction and the X-axis direction will be referred to as a Z-axis direction.

(Overall Configuration of Printing Device)

First, with reference to FIG. 1 to FIG. 3, a description will be given of an overall configuration of the printing device 100. The printing device 100 includes an ink ejection device 1 and a plate device 2. With this configuration, the printing device 100 is able to perform both digital printing (inkjet printing) and analog printing (printing using a plate). That is, the printing device 100 is a hybrid printing system. The printing device 100 includes a conveyance device 3 in addition to the ink ejection device 1 and the plate device 2. The printing device 100 further includes a control device 4, a fabric feeding device 5, a fixing device 6a, and a cleaning device 6b.

The conveyance device 3 conveys the fabric 7. The plate device 2 is provided on a conveyance line for the fabric 7 conveyed by the conveyance device 3. The ink ejection device 1 is attachable to and detachable from the conveyance line for the fabric 7. For example, the ink ejection device 1 is attachable to an existing conveyance line (a conveyance line on which the plate device 2 is already placed). Further, in a case where a plurality of plate devices 2 are placed on the existing conveyance line, any one of the plate devices 2 may be detached to be replaced by the ink ejection device 1. Furthermore, the ink ejection device 1 placed on the existing conveyance line may be detached. That is, the ink ejection device 1 is attachable to and detachable from the printing device 100 (the conveyance line for the fabric 7 in the conveyance device 3). Thus, the ink ejection device 1 may be supplied to the market as a product on its own.

The ink ejection device 1 may be fixed to the conveyance line for the fabric 7 in the conveyance device 3. That is, the ink ejection device 1 does not necessarily have to be detachable from the conveyance line. In this case, the ink ejection device 1, the plate device 2, and the conveyance device 3 are sold in package.

The control device 4 controls the ink ejection device 1, the plate device 2, the conveyance device 3, the fabric feeding device 5, the fixing device 6a, and the cleaning device 6b. The fabric 7 rolled in a cylindrical form is set in the fabric feeding device 5. The fabric feeding device 5 feeds the fabric 7 to the conveyance device 3. The fixing device 6a has the fabric 7 conveyed into it from the conveyance device 3. The fixing device 6a fixes ink to the fabric 7. The cleaning device 6b has the fabric 7 conveyed into it from the fixing device 6a. The cleaning device 6b cleans the fabric 7.

The conveyance device 3 includes a conveyance belt 31, a drive roller 32, a driven roller 33 and a conveyance motor 34. The conveyance device 3 further includes a conveyance control portion 30. The conveyance belt 31 is wound around the drive roller 32 and the driven roller 33. The fabric 7 is stretched on the conveyance belt 31 (the fabric 7 is in contact with the conveyance belt 31). The conveyance motor 34 is a motor that makes the drive roller 32 rotate. The conveyance control portion 30 is a circuit board that includes a control circuit (for example, a CPU).

The conveyance control portion 30 receives an instruction from the control device 4, and controls the conveyance motor 34. That is, the conveyance control portion 30 makes the drive roller 32 rotate appropriately. As the drive roller 32 rotates, the conveyance belt 31 also rotates. As a result, the fabric 7 on the conveyance belt 31 is conveyed. Printing by the ink ejection device 1 and printing by the plate device 2 are performed with respect to the fabric 7 conveyed by the conveyance device 3 (the fabric 7 on the conveyance belt 31).

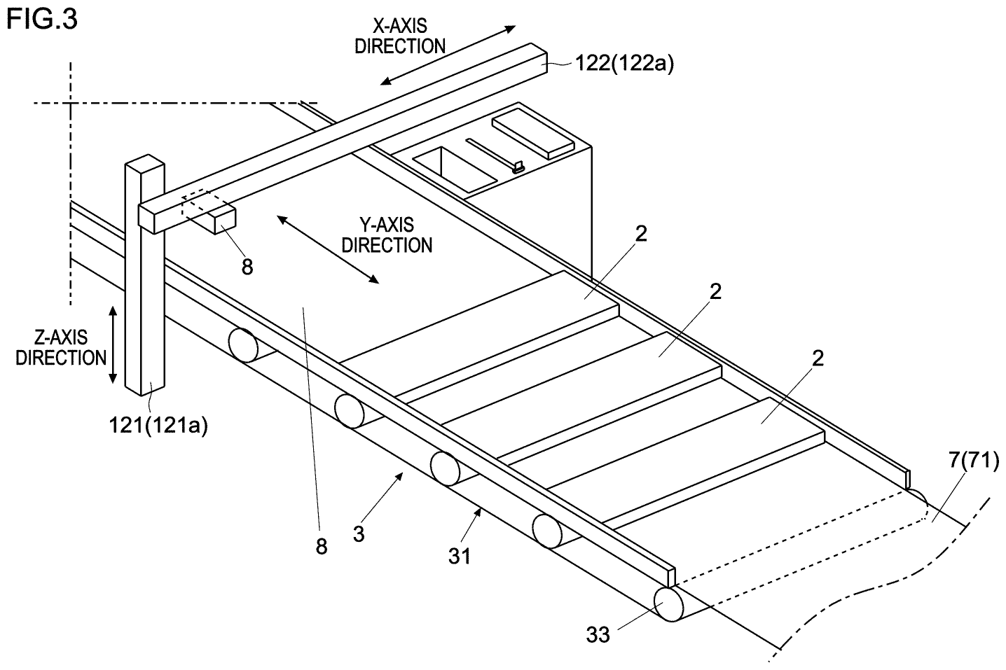

The ink ejection device 1 performs printing on the fabric 7 by ejecting ink to it. The ink ejection device 1 is a kind of inkjet printer. That is, the ink ejection device 1 includes a head 8 (see FIG. 3) which ejects ink.

Here, the ink ejection device 1 achieves printing with a serial head printing system. However, the head 8 is movable not only in the X-axis direction but also in the Z-axis direction. With this configuration, a position of the head 8 in the Z-axis direction is adjustable, for example, before, after, and during printing.

A configuration of the ink ejection device 1 will be described in detail later.

The plate device 2 performs printing on the fabric 7 by using a plate. Printing by the plate device 2 is performed with the plate pressed against the fabric 7 from above (above in the Z-axis direction). That is, the fabric 7 conveyed by the conveyance device 3 passes below the plate of the plate device 2 (below in the Z-axis direction).

In the printing by the plate device 2, a monochrome image can be printed by a single plate device 2. In a case where an image in a plurality of colors is printed, plate devices 2 of the same number as the plurality of colors are incorporated in the printing device 100. That is, the number of the plate device 2 placed is not limited to one. For example, a plurality of plate devices 2 may be placed. Hereinafter, a description will be given of the configuration of one of the plurality of plate devices 2, and since the plurality of plate devices 2 are all identical in configuration, overlapping descriptions will be omitted as to the configurations of the other plate devices 2.

The plate device 2 includes a frame 21, a screen plate 22 (corresponding to “a plate”), a squeegee 23, a squeegee moving device 24, and a lifting device 25. The frame 21 holds the screen plate 22. The frame 21 is rectangular in outer shape. The screen plate 22 is disposed within the frame 21. Color paste is placed on an upper surface of the screen plate 22. An ink transmitting portion that transmits ink (a portion through which ink is pushed out toward the fabric 7) is formed in the screen plate 22. The squeegee 23 is formed in a spatula shape. A lower end part of the squeegee 23 is in contact with the upper surface of the screen plate 22. The squeegee moving device 24 includes a motor. The squeegee moving device 24 moves the squeegee 23 along the upper surface of the screen plate 22. The squeegee 23 and the squeegee moving device 24 are placed in the frame 21. The lifting device 25 lifts and lowers the frame 21.

The type of the plate device 2 is not particularly limited. For example, the plate device 2 may be a rotary screen fabric printer. Or, instead, the plate device 2 may be a roller fabric printer.

(Configuration of Ink Ejection Device)

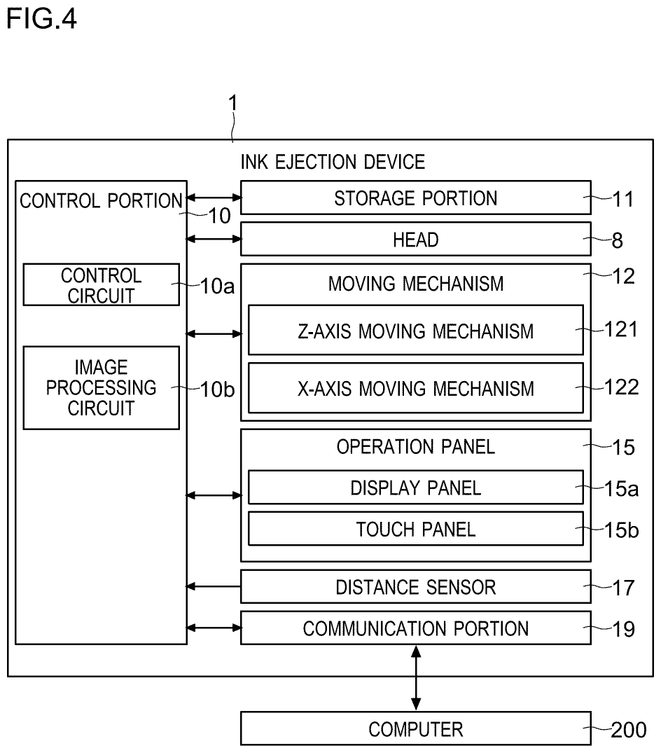

Next, with reference to FIG. 4, a configuration of the ink ejection device 1 will be described.

The ink ejection device 1 includes a control portion 10 and a storage portion 11. The control portion 10 controls the ink ejection device 1. The control portion 10 is a circuit board that includes a control circuit 10a (for example, a CPU) and an image processing circuit 10b. The control circuit 10a performs processing based on a control program and control data. The image processing circuit 10b performs image processing with respect to image data D2 (of which details will be given later) to be used for printing. The storage portion 11 includes a non-volatile storage device (for example, a ROM, an HDD, and a flash ROM) and a volatile storage device (for example, a RAM). The storage portion 11 stores therein the control program and the control data.

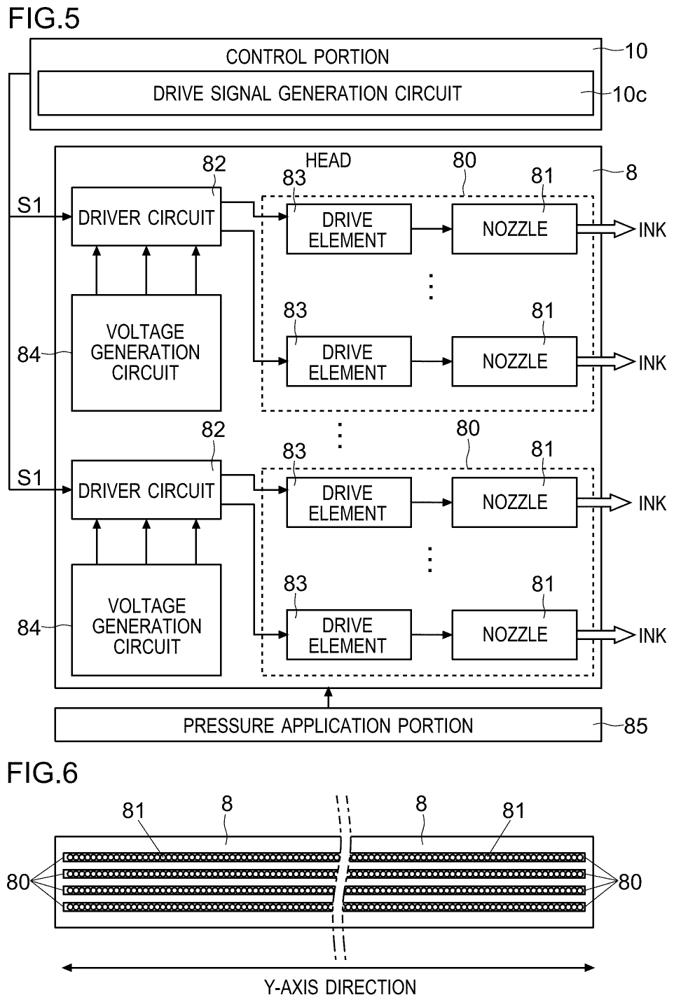

The head 8 of the ink ejection device 1 includes a plurality of nozzles 81 (see FIG. 5 and FIG. 6). The head 8 ejects ink of a plurality of colors. For example, ink of each color of black, yellow, cyan, and magenta is ejected from the head 8. In this manner, color printing is performed.

The control portion 10, during printing, makes the head 8 eject ink toward the fabric 7. The ink ejected from the head 8 adheres to a printing surface 71 of the fabric 7. In this manner, an image is printed on the printing surface 71.

The ink ejection device 1 further includes a moving mechanism 12. The moving mechanism 12 is a mechanism that moves the head 8 in two axis directions. The moving mechanism 12 includes a Z-axis moving mechanism 121 and an X-axis moving mechanism 122. The Z-axis moving mechanism 121 is a mechanism that moves the head 8 in the Z-axis direction. The X-axis moving mechanism 122 is a mechanism that moves the head 8 in the X-axis direction.

The control portion 10 controls the moving mechanism 12 to appropriately move the head 8. The control portion 10 controls the Z-axis moving mechanism 121 to adjust the position of the head 8 in the Z-axis direction (moves the head 8 in the Z-axis direction). The control portion 10 also controls the X-axis moving mechanism 122 to adjust the position of the head 8 in the X-axis direction (moves the head 8 in the X-axis direction).

The ink ejection device 1 includes an operation panel 15. The operation panel 15 includes a display panel 15a and a touch panel 15b.

The ink ejection device 1 includes a communication portion 19. The communication portion 19 communicates with a computer 200. The computer 200 is, for example, a personal computer. The communication portion 19 receives print data D1 (of which details will be given later) from the computer 200. Based on the print data D1, the control portion 10 makes the head 8 move and eject ink.

(Configuration of Head)

Next, with reference to FIG. 5 and FIG. 6, a description will be given of a configuration of the head 8.

The head 8 includes a plurality of (four) nozzle arrays 80 each corresponding to one of the colors of black, yellow, cyan, and magenta. In each nozzle array 80, a plurality of nozzles 81 are arranged in a row. Each nozzle array 80 has the same number of nozzles 81. Each nozzle array 80 ejects ink of a corresponding color. In each nozzle array 80, the plurality of nozzles 81 are arranged in the Y-axis direction. The plurality of nozzles 81 of each nozzle array 80 are formed to be equally spaced from each other in the Y-axis direction. A range from an upstream-side end nozzle 81 to a downstream-side end nozzle 81 in the Y-axis direction (the conveyance direction) is an image-forming range in which image is formed in one event of ink ejection.

The head 8 includes a drive element 83. One drive element 83 is provided for each nozzle 81. The drive element 83 is a piezoelectric element (for example, a piezo element).

The head 8 further includes a driver circuit 82. One driver circuit 82 is provided for one nozzle array 80. The driver circuit 82 controls ON/OFF of voltage application to the drive element 83 (that is, controls ink ejection). The control portion 10 feeds the image data D2 (data indicating a nozzle 81 that is to eject ink) to the driver circuit 82 for each line. The driver circuit 82 applies a pulse voltage to the drive element 83 of the nozzle 81 that is to eject ink. The drive element 83 to which the voltage is applied is deformed. The pressure resulting from the deformation of the drive element 83 is applied to a supply flow path (not shown) of the ink to the nozzles 81. In this manner, the ink is ejected from the nozzle 81 corresponding to the drive element 83 to which the voltage is applied. Here, the driver circuit 82 does not apply a voltage to the drive element 83 corresponding to the nozzle 81 that is not to eject ink.

The head 8 further includes a voltage generation circuit 84. One voltage generation circuit 84 is provided for one driver circuit 82. The voltage generation circuit 84 generates a plurality of types of voltages. The driver circuit 82 applies a voltage generated by the voltage generation circuit 84 to the drive element 83. As the voltage applied to the drive element 83 increases, the deformation of the drive element 83 increases, and accordingly more ink is ejected. As the voltage applied to the drive element 83 decreases, the deformation of the drive element 83 decreases, and accordingly less ink is ejected. In this manner, the ink ejection amount can be adjusted.

The control portion 10 includes a drive signal generation circuit 10c. The drive signal generation circuit 10c generates a drive signal S1. The drive signal S1 is a signal for driving the head 8 (the driver circuits 82). The drive signal generation circuit 10c generates a clock signal, for example. The head 8 (the driver circuits 82) ejects ink each time the drive signal S1 rises. A reference cycle of ink ejection is determined in advance. The control portion 10 makes the drive signal generation circuit 10c generate the drive signal S1 such that ink is ejected at the reference cycle.

(Configuration of Moving Mechanism)

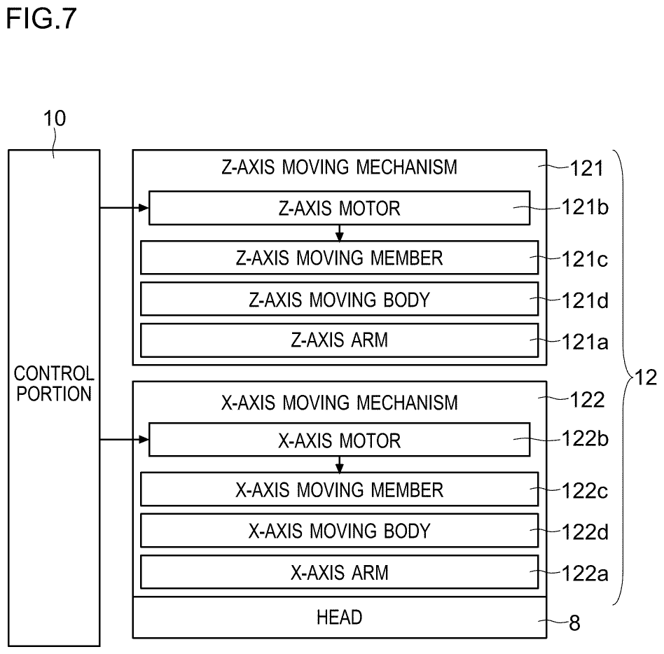

Next, with reference to FIG. 7, a description will be given of a configuration of the moving mechanism 12 (the Z-axis moving mechanism 121 and the X-axis moving mechanism 122).

The Z-axis moving mechanism 121 includes a Z-axis arm 121a. The Z-axis arm 121a is a member having a quadrangular-prism shape. The Z-axis arm 121a has a Z-axis motor 121b, a Z-axis moving member 121c, and a Z-axis moving body 121d built therein. The Z-axis motor 121b is, for example, a stepping motor. The Z-axis motor 121b is rotatable both forwardly and reversely. The control portion 10 controls the Z-axis motor 121b. The Z-axis motor 121b makes the Z-axis moving member 121c rotate. The Z-axis moving member 121c is, for example, a ball screw. The Z-axis moving body 121d is integrated with a nut attached to the ball screw. Thereby, rotational movement of the Z-axis motor 121b is converted into linear movement. As a result, the Z-axis moving body 121d moves in the Z-axis direction. The Z-axis arm 121a guides the movement of the Z-axis moving body 121d in the Z-axis direction.

The X-axis moving mechanism 122 includes an X-axis arm 122a. The X-axis arm 122a is a member having a quadrangular prism. The X-axis arm 122a has an X-axis motor 122b, an X-axis moving member 122c and an X-axis moving body 122d built therein. The X-axis motor 122b is, for example, a stepping motor. The X-axis motor 122b is rotatable both forwardly and reversely. The control portion 10 controls the X-axis motor 122b. The X-axis motor 122b makes the X-axis moving member 122c rotate. The X-axis moving member 122c is, for example, a ball screw. The X-axis moving body 122d is integrated with a nut attached to the ball screw. Thereby, rotational movement of the X-axis motor 122b is converted into linear movement. As a result, the X-axis moving body 122d moves in the X-axis direction. The X-axis arm 122a guides the movement of the X-axis moving body 122d in the X-axis direction.

The Z-axis moving body 121d is connected to the X-axis moving mechanism 122. For example, to an end part of the X-axis arm 122a, the Z-axis moving body 121d is connected. With this configuration, the X-axis arm 122a moves in the Z-axis direction with the movement of the Z-axis moving body 121d. The control portion 10 controls the Z-axis motor 121b to change a position of the X-axis arm 122a in the Z-axis direction.

The head 8 is fitted to the X-axis moving body 122d such that an array direction of each nozzle array 80 is parallel to the Y-axis direction. Specifically, the head 8 is held by a carriage (not shown). The carriage is fitted to the X-axis moving body 122d. With this configuration, the head 8 moves in the X-axis direction with the movement of the X-axis moving body 122d.

The control portion 10 controls the Z-axis motor 121b to move the Z-axis moving body 121d in the Z-axis direction. In this manner, together with the Z-axis moving body 121d, the head 8 (the X-axis arm 122a) moves in the Z-axis direction. Further, the control portion 10 controls the X-axis motor 122b to move the X-axis moving body 122d in the X-axis direction. In this manner, together with the X-axis moving body 122d, the head 8 moves in the X-axis direction.

During printing, the control portion 10 controls the X-axis motor 122b to perform scanning in which the head 8 is moved in the X-axis direction. The control portion 10 makes the head 8 eject ink during the scanning.

The control portion 10, by controlling the Z-axis motor 121b, adjusts the position of the head 8 in the Z-axis direction. In this manner, a distance between the printing surface 71 of the fabric 7 and a nozzle surface of the head 8 can be changed.

Here, the carriage may be movable with respect to the X-axis arm 122a in the Z-axis direction. The head 8 may be movable with respect to the carriage in the Z-axis direction.

(Print Data Including Image Data)

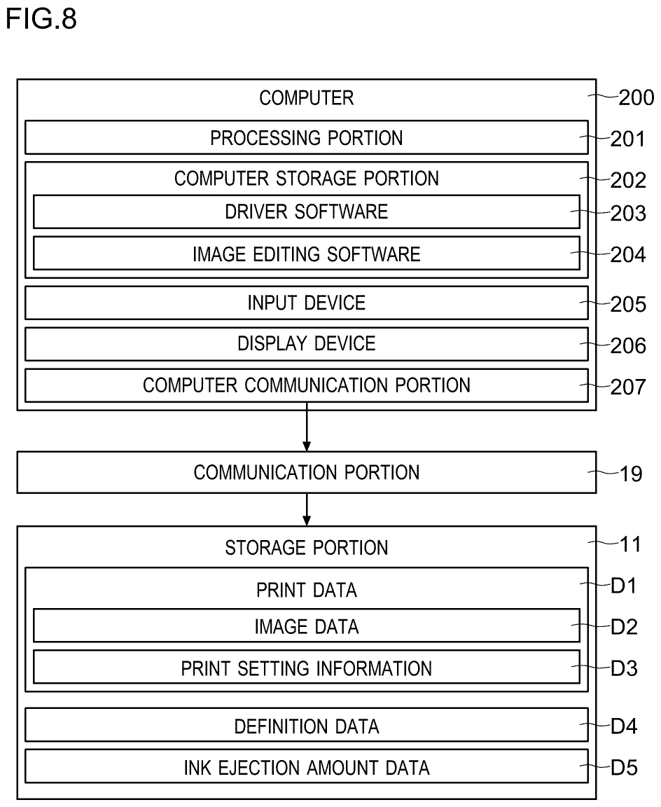

Next, with reference to FIG. 8, a description will be given of the print data D1 including the image data D2.

The computer 200 transmits the print data D1 to the ink ejection device 1. The computer 200 can be considered as part of the printing device 100. The computer 200 includes a processing portion 201, a computer storage portion 202, an input device 205, a display device 206, and a computer communication portion 207. The processing portion 201 is a circuit board that includes a processing circuit (for example, a CPU). The computer storage portion 202 includes a ROM, a RAM, and an HDD. The computer storage portion 202 stores therein driver software 203 for generating the print data D1. The computer storage portion 202 further stores therein image editing software 204 for editing the image data D2 to be used for printing. The input device 205 is an input appliance such as a hardware keyboard, a printing device, etc. A user uses the input device 205 to input the image data D2. The user uses the input device 205 to input a printing command. The display device 206 is a display. The computer communication portion 207 is a communication interface.

In response to the input of the printing command, the processing portion 201 activates the driver software 203. The processing portion 201, based on the driver software 203, makes the display device 206 display a setting screen for accepting print settings from the user. The input device 205 accepts the print settings from the user. For example, the input device 205 accepts settings of image printing position, printing resolution, image type, and ejection-time distance (of which details will be given later) in a unit print range E1 (of which details will be given later).

The processing portion 201 generates the print data D1 based on the driver software 203. The print data D1 includes the image data D2 and print setting information D3. The processing portion 201 generates the image data D2 of a resolution set by the user (a user-specified resolution). Further, the processing portion 201 has details of the print settings made by the user included in the print setting information D3. For example, the processing portion 201 has the following items included in the print setting information D3: the image printing position, the printing resolution, the image type, and the ejection-time distance. In a case of printing a plurality of types of images in one unit print range E1, the processing portion 201 has a plurality of pieces of image data D2 corresponding to the plurality of types of images included in the print data D1, and has details of a plurality of print settings respectively corresponding to the plurality of types of images included in the print data D1.

Then, the processing portion 201, by using the computer communication portion 207, transmits the print data D1 to the ink ejection device 1 (the print data D1 is input to the ink ejection device 1). The storage portion 11 of the ink ejection device 1 stores the print data D1 therein. Here, it may be only the image data D2 that is input to the ink ejection device 1. In such a case, the operation panel 15 of the ink ejection device 1 accepts the print settings from the user. Then, the control portion 10 of the ink ejection device 1 generates the print data D1.

(Conveyance of Fabric and Printing on Fabric)

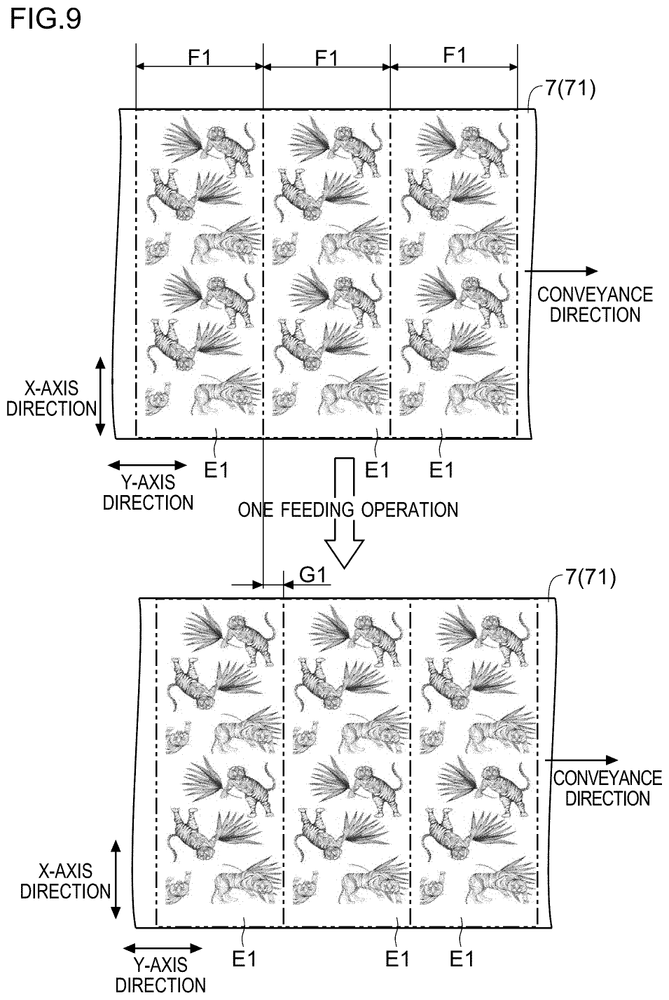

Next, with reference to FIG. 9, a description will be given of conveyance of the fabric 7 and printing on the fabric 7.

The conveyance device 3 conveys the fabric 7 in the Y-axis direction by performing an operation of repeating a feeding operation of feeding the fabric 7 in the Y-axis direction (the conveyance direction) by a certain amount and suspension of the feeding operation. That is, the conveyance device 3 feeds the fabric 7 in the Y-axis direction by the certain amount at a time. In the following description, the operation of repeating the feeding operation and the suspension of the feeding operation (the operation performed by the conveyance device 3 when conveying the fabric 7) will be referred to as conveyance operation, and will be distinguished from the feeding operation.

In printing by the printing device 100 (the ink ejection device 1 and the plurality of plate devices 2), the fabric 7 as the target of the printing is sectioned into a plurality of unit print ranges E1. In FIG. 9, the unit print ranges E1 are surrounded by two-dot chain lines. The length of the unit print range E1 in the Y-axis direction is the same as the length of the screen plate 22 of the plate device 2 in the Y-axis direction. In the following description, the length of the unit printing range E1 in the Y-axis direction will be referred to as a prescribed length F1. The length of the unit print range E1 in the X-axis direction is the same as the length of the fabric 7 in the X-axis direction. When a plurality of plate devices 2 are placed in the printing device 100, a distance in the Y-axis direction between the screen plates 22 of the plate devices 2 adjacent to each other in the Y-axis direction is set to the prescribed length F1.

When printing is performed, the conveyance device 3 feeds the textile 7 in the Y-axis direction by an amount corresponding to a predetermined length G1 at a time (the conveyance device 3 repeats the feeding operation and the suspension of the feeding operation). When the conveyance device 3 performs the feeding operation once, the state illustrated in the upper view of FIG. 9 changes to the state illustrated in the lower view of FIG. 9.

For example, the control portion 10 of the ink ejection device 1 sets the predetermined length G1 (a feeding amount in one feeding operation by the conveyance device 3). The control portion 10, when setting the predetermined length G1, recognizes the user-specified resolution which is included in the print setting information D3 of the print data D1 received from the computer 200. Then, the control portion 10 sets the predetermined length G1 based on the user-specified resolution.

Here, the number of the nozzles 81 included in each nozzle array 80 of the head 8 of the ink ejection device 1 per unit length (one inch) is equal to or less than the number of dots per unit length of any printing resolution that is settable. The predetermined length G1 is shorter than the length of each nozzle array 80 in the Y-axis direction.

Thus, where the length of each nozzle array 80 in the Y-axis direction is represented by A, the user-specified resolution (the resolution of printing by the ink ejection device 1) is represented by B, and the number of the nozzles 81 per unit length of each nozzle array 80 is represented by C, the control portion 10 sets the predetermined length G1 to be equal to (A÷(B÷C))+1 dots.

As an example, assume a case where 600 nozzles 81 are included in each nozzle array 80. Also assume that a resolution B specified by the user is 600 dpi, and a number C of the nozzles 81 included in each nozzle array 80 per unit length is 150 (150 dpi). The unit length is 1 inch in accordance with the printing resolution. In this case, the length A of each nozzle array 80 in the Y-axis direction is about 4 (=600÷150) inches, such that (A÷(B÷C))=4÷(600÷150)=1. Accordingly, in the case where the user-specified resolution is 600 dpi, the predetermined length G1 is 1 inch+1 dot.

As another example, assume a case where 600 nozzles are included in each nozzle array 80. Here, assume that the resolution B specified by the user is 300 dpi, and the number C of the nozzles 81 included in each nozzle array 80 per unit length is 150 (150 dpi). The unit length is 1 inch in acordance with the printing resolution. In this case, the length A of each nozzle array 80 in the Y-axis direction is about 4 (=600÷150) inches, such that (A÷(B÷C))=4÷(300÷150)=2. Accordingly, in the case where the user-specified resolution is 300 dpi, the predetermined length G1 is 2 inches+1 dot.

The control portion 10 transmits information indicating the predetermined length G1 in accordance with the user-specified resolution to the control device 4 as conveyance control information. The control device 4 transmits the conveyance control information to the conveyance device 3. The conveyance control portion 30 of the conveyance device 3 recognizes the predetermined length G1 indicated by the conveyance control information. The conveyance control portion 30 sets an amount corresponding to the recognized predetermined length G1 as a feeding amount in the feeding operation performed in printing. Then, when printing is performed, the conveyance device 3 feeds the fabric 7 by the feeding amount in accordance with the user-specified resolution (the feeding amount in one feeding operation by the conveyance device 3 is an amount in accordance with the user-specified resolution). That is, the conveyance device 3 changes the feeding amount by which to feed the fabric 7 in one feeding operation in accordance with the resolution of printing by the ink ejection device 1.

The ink ejection device 1 performs printing with respect to the fabric 7 while the conveyance device 3 is executing the conveyance operation (the operation of repeating the feeding operation and the suspension of the feeding operation). A printing range in each printing event by the ink ejection device 1 is the unit print range E1. The printing range in one printing event by the ink ejection device 1 is the same range as the printing range in one printing event by each screen plate 22 of the plurality of plate devices 2.

The ink ejection device 1 prints an image on an area in the unit print range E1 where printing by the plate device 2 is not performed. For example, among images to be printed on the fabric 7, images in a plurality of colors and gradation images are printed by the ink ejection device 1. The fabric 7 is sectioned into a plurality of unit print ranges E1, in which the same images are printed.

When the feeding operation by the conveyance device 3 is suspended, the control portion 10 of the ink ejection device 1 controls the X-axis moving mechanism 122 to perform scanning in which the head 8 is made to move in the X-axis direction. A scanning starting position is a position where one of opposing sides of the fabric 7 parallel to the Y-axis direction (a side on one side in the X-axis direction and a side on the other side in the X-axis direction direction) faces such one of the plurality of nozzle arrays 80 of the head 8 as is located on the most other side in the X-axis direction. A scanning ending position is a position where the other one of the opposing sides of the fabric 7 parallel to the Y-axis direction faces such one of the plurality of nozzle arrays 80 of the head 8 as is located on the most one side in the X-axis direction.

While performing scanning with the head 8 (while moving the head 8 from the scanning starting position to the scanning ending position), the control portion 10 makes the head 8 eject ink based on the print data D1 (the image data D2 included in the print data D1). After one scanning event ends (that is, after moving the head 8 from the scanning starting position to the scanning ending position once), the control portion 10 controls the X-axis moving mechanism 122 to return the head 8 from the scanning ending position to the scanning starting position. Here, an ink ejection cycle of ejecting ink from the head 8 is determined in advance. A moving speed of the head 8 in the X-axis direction is set based on the printing resolution and the ink ejection cycle. The control portion 10 sets the moving speed of the head 8 in the X-axis direction such that the head 8 moves by a distance corresponding to one dot in each ejection cycle.

When one scanning event ends, the conveyance control portion 30 of the conveyance device 3 has the feeding operation of feeding the fabric 7 in the Y-axis direction performed and then suspends the feeding operation. At this time, the fabric 7 is fed by an amount corresponding to the predetermined length G1. When the fabric 7 is fed in the Y-axis direction by an amount corresponding to the predetermined length G1 after one scanning event ends, the control portion 10 of the ink ejection device 1 has scanning performed with the head 8 (ejection of ink) again and then returns the head 8 from the scanning ending position back to the scanning starting position.

As described above, the ink ejection device 1 performs scanning with the head 8 once each time the conveyance device 3 performs the feeding operation once. The conveyance device 3 performs the feeding operation of feeding the fabric 7 once by an amount corresponding to the predetermined length G1 each time one scanning event ends. That is, after one scanning event ends, the fabric 7 is fed by an amount in accordance with the printing resolution of the ink ejection device 1 (the user-specified resolution) (i.e., an amount corresponding to the predetermined length G1).

For example, in a case where the user-specified resolution is 600 dpi, the conveyance device 3 feeds the fabric 7 by an amount corresponding to 1 inch+1 dot in one feeding operation. In a case where the user-specified resolution is 300 dpi, the conveyance device 3 feeds the fabric 7 by an amount corresponding to 2 inches+1 dot in one feeding operation.

Thereby, in the ink ejection device 1, even if the number of the nozzles 81 per unit length of each nozzle array 80 of the head 8 is equal to or less than the number of dots per unit length of the user-specified resolution, the number of ink-droplet impacts on the fabric 7 per unit area (one square inch) of the fabric 7 can be made equal to the number of dots per unit area that is based on the user-specified resolution.

Further, in accordance with the user-specified resolution, the conveyance device 3 changes the feeding amount by which to feed the fabric 7 in one feeding operation. In this manner, printing can be performed at the user-specified resolution.

The plurality of plate devices 2 each perform printing with respect to the fabric 7 when the conveyance operation (the operation of repeating the feeding operation and the suspension of the feeding operation) is temporarily suspended. A printing range in one printing event by each screen plate 22 of the plurality of plate devices 2 (hereinafter referred to as a screen printing range) is the unit print range E1. The screen printing range is the same as a printing range in one event of printing performed by the ink ejection device 1.

The plurality of plate devices 2 each print an image on such an area in the unit print range E1 where printing by the ink ejection device 1 is not performed. For example, among images to be printed on the fabric 7, solid images are printed by the plurality of plate devices 2. The plurality of plate devices 2 each print an image in a respective corresponding color on the unit print range E1. Given below is a description of a flow of printing performed by one plate device 2 among the plurality of plate devices 2, and it is assumed that the other plate devices 2 also perform printing in the same manner.

When a unit print range E1 of the fabric 7 enters the screen printing range of the plate device 2, the conveyance control portion 30 of the conveyance device 3 temporarily suspends the conveyance operation. The temporary suspension of the conveyance operation performed by the conveyance device 3 continues until the printing on the unit print range E1 of the fabric 7 by the plate device 2 is completed. When one unit print range E1 of the fabric 7 has entered the screen printing range of one plate device 2, it means that another unit print range E1 of the fabric 7 has entered the screen printing range of another plate device 2.

When the conveyance operation by the conveyance device 3 is temporarily suspended, the ink ejection device 1 performs one scanning event with the head 8. Even after this scanning event is completed, the plate device 2 is made to perform printing on the fabric 7, and thus the conveyance device 3 does not perform the feeding operation. That is, the conveyance operation performed by the conveyance device 3 remains temporarily suspended. Accordingly, the ink ejection device 1 is in a standby state.

When the conveyance operation by the conveyance device 3 is temporarily suspended, the control device 4 makes the plate device 2 perform printing. At this time, the control device 4 controls the lifting device 25 to move the frame 21 in a direction toward the fabric 7 (downward in the Z-axis direction) until a lower surface of the screen plate 22 comes into contact with the fabric 7. Thereafter, the control device 4 controls the squeegee moving device 24 to make the squeegee 23 reciprocate in the X-axis direction inside the frame 21.

The squeegee 23 reciprocates in the X-axis direction while in contact with the upper surface of the screen plate 22. That is, the squeegee 23 rubs against the upper surface of the screen plate 22. At this time, since color paste is placed on the upper surface of the screen plate 22, the color paste is pushed out through the ink transmitting portion of the screen plate 22 toward the fabric 7. In this manner, an image is printed on the fabric 7.

Thereafter, the control device 4 controls the lifting device 25 to move the frame 21 in a direction away from the fabric 7 (upward in the Z-axis direction). In this manner, the lower surface of the screen plate 22 and the fabric 7 are brought into a state of being separated from each other. In the printing with respect to the unit print range E1 of the fabric 7 by the plate device 2, the process so far is performed as one set.

After the printing with respect to the unit print range E1 of the fabric 7 by the plate device 2 is completed, the conveyance device 3 resumes the conveyance operation, and conveys the fabric 7 in the Y-axis direction (the conveyance direction). That is, the conveyance device 3 repeats the feeding operation and the suspension of the feeding operation. When the fabric 7 is fed by an amount corresponding to the predetermined length G1, the ink ejection device 1 performs scanning with the head 8. The control device 4 makes the plate device 2 stand by until the next unit print range E1 enters the screen printing range of the plate device 2.

The conveyance device 3 temporarily suspends the conveyance operation each time a unit print range E1 enters the screen printing range of the plate device 2. That is, the conveyance device 3 repeats the conveyance operation and the temporary suspension of the conveyance operation. The control device 4 makes the plate device 2 perform printing each time the conveyance operation by the conveyance device 3 is temporarily suspended (each time a unit print range E1 enters the screen printing range of the plate device 2).

For example, the ink ejection device 1 is installed on an upstream side of any of installation areas of the plurality of plate devices 2 in the Y-axis direction (the conveyance direction). With this configuration, the ink ejection device 1 completes printing with respect to a last unit print range E1 of the plurality of unit print ranges E1 of the fabric 7 at a timing earlier than the plurality of plate devices 2. Accordingly, in printing with respect to one roll of the fabric 7, there occurs a period during which printing by the ink ejection device 1 is not performed (a period during which printing is performed only by the plurality of plate devices 2).

When printing by the ink ejection device 1 is not performed, there is no need of adjusting the feeding amount in one feeding operation performed by the conveyance device 3 in accordance with the user-specified resolution. That is, even if the feeding amount by which to feed the fabric 7 in one feeding operation is increased (even if the fabric 7 is conveyed faster), it will have no effect on image quality.

Thus, after the printing to be done by the ink ejection device 1 is completed, that is, when no printing is performed by the ink ejection device 1 (when printing is performed only by the plurality of plate devices 2), the conveyance control portion 30 of the conveyance device 3 changes the feeding amount by which to feed the fabric 7 in one feeding operation. For example, when all printing to be done by the ink ejection device 1 is completed, a notification to this effect is transmitted from the control device 4 to the conveyance device 3. Based on the notification, the conveyance control portion 30 makes a judgment on whether or not to change the feeding amount in one feeding operation.

When printing by the ink ejection device 1 is not performed, the conveyance control portion 30 changes the feeding amount in one feeding operation to an amount corresponding to the length of the screen plate 22 of the plate device 2 in the Y-axis direction. In this case, when printing by the plate device 2 with respect to the unit print range E1 of the fabric 7 is completed, the conveyance device 3 feeds the fabric 7 in one single feeding operation by the amount corresponding to the length of the screen plate 22 of the plate device 2. The control device 4 makes a time interval between making the plate device 2 perform a printing event and making the plate device 2 perform a next printing event shorter than an initial time interval.

This contributes to quicker completion of printing by the plurality of plate devices 2, and thus to improved productivity.

Here, depending on the types of images to be printed on the fabric 7, the ink ejection device 1 may perform no printing at all with respect to the roll of the fabric 7. In this case, from a starting time point of the printing with respect to the roll of the fabric 7, the feeding amount in one feeding operation by the conveyance device 3 can be set to the amount corresponding to the length of the screen plate 22 of the plate device 2 in the Y-axis direction.

(Setting of Ejection-Time Distance)

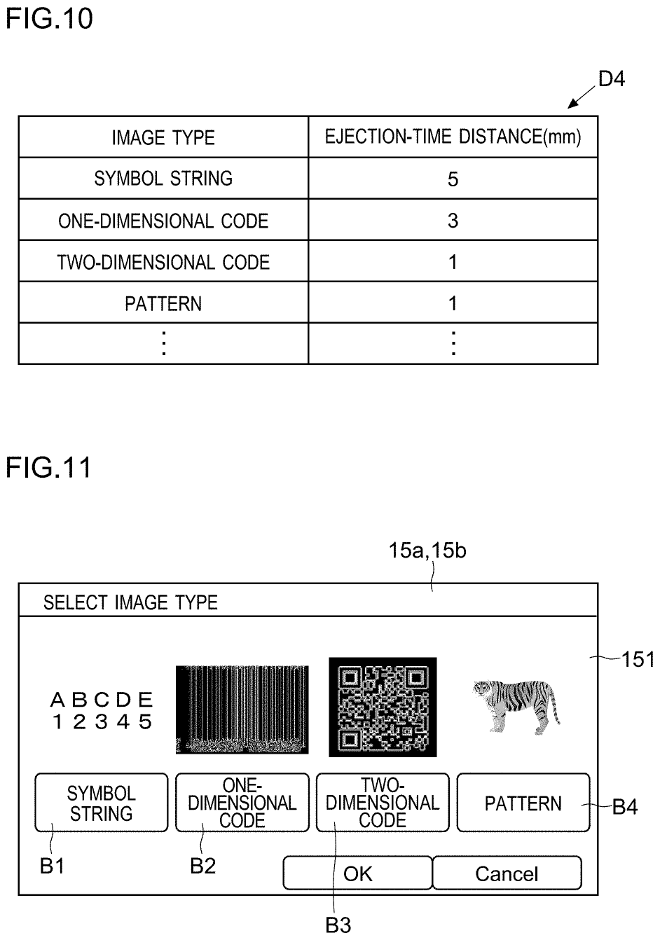

Next, with reference to FIG. 10 to FIG. 12, a description will be given of setting of the ejection-time distance.

The ink ejection device 1 includes the Z-axis moving mechanism 121. With this configuration, the head 8 can be moved in the Z-axis direction. Accordingly, the distance of interval between the printing surface 71 of the fabric 7 and the nozzles 81 (nozzle surface) of the head 8 can be adjusted.

The control portion 10 of the ink ejection device 1 sets the ejection-time distance in accordance with an image to be printed on the fabric 7 or the type (material, size, surface roughness, etc.) of the fabric 7. The ejection-time distance is a distance between the nozzles 81 and the printing surface 71 (a distance between the nozzles 81 and the printing surface 71 during printing) when the head 8 ejects ink toward the printing surface 71. The control portion 10 sets the ejection-time distance, and controls the Z-axis moving mechanism 121 (moves the head 8 in the Z-axis direction) such that the distance between the nozzles 81 and the printing surface 71 is equal to the set ejection-time distance. A plurality methods are prepared as methods for setting the ejection-time distance.

1. Setting of Ejection-Time Distance Based on Print Setting Information D3

The control portion 10 of the ink ejection device 1 can set the ejection-time distance based on the print setting information D3. The print setting information D3 is included in the print data D1. The print setting information D3 is associated with the image data D2.

The print setting information D3 includes information set in the driver software 203 of the computer 200. In a case where the print setting information D3 includes information indicating an image type, the control portion 10 can set the ejection-time distance based on the image type defined in the print setting information D3.

To set the ejection-time distance based on an image type, the storage portion 11 stores therein definition data D4 in a non-volatile manner (see FIG. 8). The definition data D4 is data that defines the ejection-time distance for each image type. An example of the definition data D4 is shown in FIG. 10.

In the definition data D4 shown in FIG. 10, it is defined that the ejection-time distance is 5 mm for the image type of symbol string. Here, symbols constituting a symbol string can be letters, digits, etc. A symbol string is mainly composed of letters, digits, etc., and made by arranging letters, digits, etc. in a row. Examples of the symbol string include a corporate name, a mail address, a telephone number, and a date and time.

Further, in the definition data D4 shown in FIG. 10, it is defined that the ejection-time distance is 1 mm for the image types of two-dimensional code (QR code (a registered trademark), for example), pattern (design), etc. Further, in the definition data D4 shown in FIG. 10, it is defined that the ejection-time distance is 3 mm for the image type of one-dimensional code (a bar code, for example).

Here, as the distance between the nozzles 81 and the printing surface 71 increases, it takes longer for ink droplets ejected from the nozzles 81 to impact on the printing surface 71. As the time from the ink ejection to the ink impact is longer, it becomes more likely that ink droplets will be affected by the gravity, an air flow, etc. Thus, as the distance between the nozzles 81 and the printing surface 71 increases, it becomes more likely that ink droplets will miss their target impact positions on the printing surface 71. On the other hand, as the distance between the nozzles 81 and the printing surface 71 decreases, a more precise image can be printed on the printing surface 71.

Thus, the definition data D4 may be set such that the more precisely an image should be printed, the shorter the ejection-time distance is. For example, a two-dimensional code includes dots (blocks), and based on sizes of the dots, reading of information from the two-dimensional code is performed. If a dot in a two-dimensional code has a blurred outline, or if a dot in the two-dimensional code is inappropriately sized, it may prevent correct reading of information from the two-dimensional code. To prevent this, the definition data D4 is defined such that the ejection-time distance for the image type of two-dimensional code is of a minimum level. Also for patterns, detailed and precise printing is preferable, and thus the definition data D4 is defined such that the ejection-time distance is of the minimum level also for the image type of pattern.

The printing surface 71 of the fabric 7 is not necessarily a flat surface. The fabric 7 can have an uneven surface. In such a case, a short distance between the nozzles 81 and the printing surface 71 may cause collision of the fabric 7 with the nozzles 81. Repeated collision of the printing surface 71 with the nozzles 81 may invite trouble of the head 8 (the nozzles 81). In view of preventing such contact between the nozzles 81 and the printing surface 71, it is preferable to increase the distance between the nozzles 81 and the printing surface 71.

Thus, the definition data D4 may be set such that the less an image needs to be printed precisely, the longer the ejection-time distance is. For example, a symbol string (a letter string) includes many solid areas. Thus, a minor deviation of an ink impact position will cause no problem. Further, properly scattered ink-droplet impact positions may make it unlikely for unevenness of color to occur. Thus, the ejection-time distance for the image type of symbol string is set to be rather long.

On the other hand, one-dimensional codes are scanned. Thus, a one-dimensional code needs to be printed with precision to some extent. However, one-dimensional codes do not need to be printed so precisely as two-dimensional codes. Thus, the ejection-time distance for the image type of one-dimensional code is set to be shorter than for symbol strings but wider than for two-dimensional codes.

2. Setting of Ejection-Time Distance Based on Image Data D2.

The control portion 10 of the ink ejection device 1 can set the ejection-time distance based on the image data D2. When setting the ejection-time distance based on the image data D2, the control portion 10 analyzes the image data D2, and identifies the type of an image included in the image data D2. Then, the control portion 10 sets the ejection-time distance based on the identified image type and the definition data D4. Here, when a plurality of pieces of the image data D2 are used for printing with respect to the fabric 7, the control portion 10 identifies the image type in each image data D2 one by one, and sets an ejection-time distance with respect to each image data D2.

In identifying the type of an image included in the image data D2, the control portion 10 checks whether or not the image in the image data D2 is an image of a two-dimensional code. Further, the control portion 10 checks whether or not the image in the image data D2 is an image of a one-dimensional code. Further, the control portion 10 checks whether of not the image in the image data D2 is an image of a symbol string (a letter string).

The control portion 10 sets the ejection-time distance based on the identified image type and the definition data D4. For example, when none of a two-dimensional code, a one-dimensional code, and a symbol string is included in the image data D2, the control portion 10 identifies the type of image as the image type of pattern. Here, if images of two or more types among the image types of two-dimensional code, one-dimensional code, symbol string, and pattern are included in the image data D2, the control portion 10 applies the minimum or maximum one of the ejection-time distances corresponding to such image types.

3. Setting of Ejection-Time Distance Via Operation Panel 15

The operation panel 15 of the ink ejection device 1 accepts, from the user, selection of the type of an image to be printed on the fabric 7. In response to a predetermined operation performed with respect to the operation panel 15, the control portion 10 makes the display panel 15a display an image type selection screen 151 as shown in FIG. 11. The user performs touch operation on the image selection screen 151 to select an image type.

Displayed on the image selection screen 151 are a first selection button B1, a second selection button B2, a third selection button B3, and a fourth selection button B4. When the image to be printed on the printing surface 71 is a symbol string, the user operates the first selection button B1. When the image to be printed on the printing surface 71 is a one-dimensional code, the user operates the second selection button B2. When the image to be printed on the printing surface 71 is a two-dimensional code, the user operates the third selection button B3. When the image to be printed on the printing surface 71 is a pattern, the user operates the fourth selection button B4.

The control portion 10 sets the ejection-time distance based on the image type selected by the user and the definition data D4. Image types different from those of symbol string, one-dimensional code, two-dimensional code, and pattern may also be included in the options. If symbol string is selected as the image type, the control portion 10 sets a first distance as the ejection-time distance. If one-dimensional code is selected as the image type, the control portion 10 sets a second distance as the ejection-time distance, the second distance being shorter than the first distance. If two-dimensional code or pattern is selected as the image type, the control portion 10 sets a third distance as the ejection-time distance, the third distance being shorter than the second distance.

4. Setting of Ejection-Time Distance Based on Surface Roughness (Smoothness Level) of Fabric 7

There are various types of fabric 7 to be conveyed by the conveyance device 3. That is, the type of the fabric 7 on which the ink ejection device 1 performs printing may change.

Ink spreads more on a rougher surface of the fabric 7. In a case where the fabric 7 has a rough surface, if printing is performed by intentionally making ink-droplet impact positions deviate, the resulting image may have less unevenness. This is because ink can be made to penetrate even in minute hollows on the surface of the fabric 7. Further, the deviation of ink-droplet impact positions tends to be more noticeable on a smoother surface of the fabric 7.

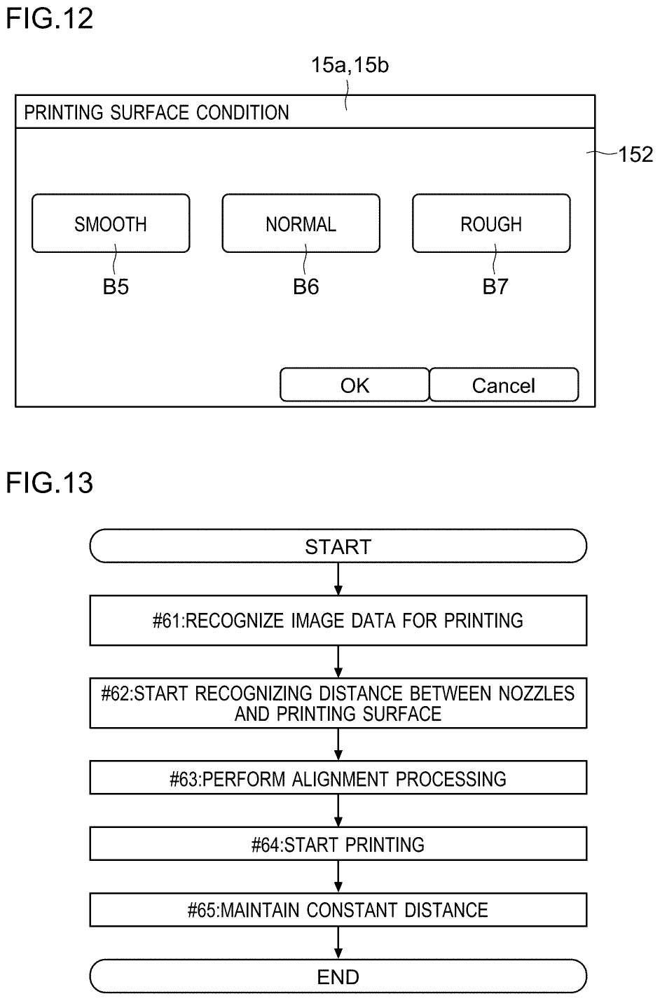

Thus, the operation panel 15 of the ink ejection device 1 accepts setting of the smoothness level of the surface of the fabric 7. In response to an operation performed on the operation panel 15, the control portion 10 makes the display panel 15a display a smoothness level selection screen 152 as shown in FIG. 12. The user performs touch operation on the smoothness level selection screen 152 to select a smoothness level.

Displayed on the smoothness level selection screen 152 are a fifth selection button B5, a sixth selection button B6, and a seventh selection button B7. When using the fabric 7 whose surface is of a high smoothness level (the fabric 7 with a smooth surface), the user operates the fifth selection button B5. When using the fabric 7 whose surface is of a normal smoothness level, the user operates the sixth selection button B6. When using the fabric 7 whose surface is of a low smoothness level (the fabric 7 with a rough surface), the user operates the seventh selection button B7.

Here, the ejection-time distance is determined in advance for each smoothness level. In other words, for each of the fifth, sixth, and seventh selection buttons B5, B6, and B7, a corresponding ejection-time distance is determined in advance. For example, the ejection-time distance corresponding to the seventh selection button B7 is 5 mm. The ejection-time distance corresponding to the sixth selection button B6 is 3 mm. The ejection-time distance corresponding to the fifth selection button B5 is 1 mm. The control portion 10 sets the ejection-time distance based on the smoothness level selected by the user. The control portion 10 makes the ejection-time distance shorter as the smoothness level selected by the user is higher, and makes the ejection-time distance longer as the smoothness level selected by the user is lower.

(Control of Movement of Head in Z-Axis Direction)

Next, with reference to FIG. 13, a description will be given of how the movement of the head 8 in the Z-axis direction is controlled.

The flow in the flowchart shown in FIG. 13 starts when the ink ejection device 1 starts printing. At the starting time point in the flowchart shown in FIG. 13, the print data D1 (the image data D2 and the print setting information D3) has already been input in the ink ejection device 1.

First, the control portion 10 recognizes the image data D2 to be used for printing (step #61). At this time, the control portion 10 recognizes the print setting information D3 associated with the image data D2. Then, the control portion 10 sets an ejection-time distance. In the following description, the ejection-time distance set by the control portion 10 may be referred to as target ejection-time distance.

Here, when a selection has been made by the user on at least either the image selection screen 151 or the smoothness level selection screen 152, the control portion 10 sets the ejection-time distance based on the selection (priority is given to the user's selection). When a selection has been made on each of the image selection screen 151 and the smoothness level selection screen 152, priority may be given to the selection made on the image selection screen 151. In this case, the control portion 10 sets the ejection-time distance based on the image type corresponding to the button selected on the image selection screen 151 (the first selection button B1, the second selection button B2, the third selection button B3, or the fourth selection button B4). Or, priority may be given to the selection made on the smoothness level selection screen 152. In this case, the control portion 10 sets the ejection-time distance based on the image type corresponding to the button selected on the smoothness level selection screen 152 (the fifth selection button B5, the sixth selection button B6, or the seventh selection button B7).

When no selection has been made either on the image selection screen 151 or on the smoothness level selection screen 152, the control portion 10 sets the ejection-time distance based on the print setting information D3. That is, even without any operation performed on the operation panel 15, the ejection-time distance is automatically set by the control portion 10. When no information indicating image types is included in the print setting information D3, the control portion 10 analyzes the image data D2 to set the ejection-time distance.

Next, based on an output of a distance sensor 17 (see FIG. 4), the control portion 10 starts distance recognition processing to recognize the distance between the nozzles 81 of the head 8 and the printing surface 71 of the fabric 7 (step #62). The distance sensor 17 is provided on the head 8.

Next, the control portion 10 performs alignment processing before starting printing with respect to the unit print range E1 (step #63). In performing the alignment processing, the control portion 10 moves the head 8 in the Z-axis direction such that the distance between the nozzles 81 and the printing surface 71 (the distance detected by the distance sensor 17) becomes equal to the target ejection-time distance.

Next, the control portion 10 starts printing with the head 8 (step #64). After starting the printing with the head 8, the control portion 10 moves the head 8 in the Z-axis direction as necessary to maintain a constant distance between the nozzles 81 and the printing surface 71 (step #65). Thereby, the distance between the nozzles 81 and the printing surface 71 is maintained to the target ejection-time distance.

To maintain the distance between the nozzles 81 and the printing surface 71 to the target ejection-time distance, the control portion 10 continues to detect the distance between the nozzles 81 and the printing surface 71 based on the output of the distance sensor 17, and when the detected distance is not equal to the target ejection-time distance, the control portion 10 adjusts the position of the head 8 in the Z-axis direction to reduce or increase the distance between the nozzles 81 and the printing surface 71 to make the distance equal to the target ejection-time distance again. That is, the control portion 10 changes the position of the head 8 in the Z-axis direction following the unevenness of the printing surface 71. Thus, even when the printing surface 71 has unevenness, the nozzles 81 do not collide with the printing surface 71.

(Adjusting Ink Ejection Amount)

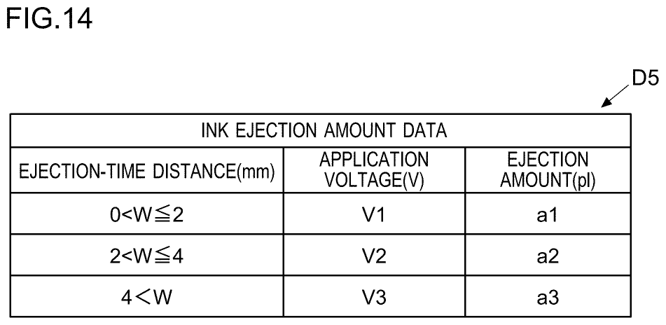

Next, with reference to FIG. 14, a description will be given of how the ink ejection amount is adjusted.

The ink ejection device 1 includes the Z-axis moving mechanism 121. With this configuration, the head 8 can be moved in the Z-axis direction. Thus, the distance between the nozzles 81 of the head 8 and the printing surface 71 of the fabric 7 can be changed as necessary. That is, the ejection-time distance is adjustable.

A shorter ejection-time distance makes it more likely for ink droplets to reach their respective target impact positions. On the other hand, a longer ejection-time distance makes it more likely for ink droplets to miss their respective target impact positions. For example, an ink droplet may impact on a dot that is not colored in the image data D2. If ink droplets miss their respective target impact positions, it may result in a reduced density of an image printed on the printing surface 71.

To suppress such inconvenience, the control portion 10 of the ink ejection device 1, when performing printing with the head 8 (when making the head 8 eject ink), adjusts the ink ejection amount from the head 8 (the ink ejection amount per dot). The control portion 10 reduces the ink ejection amount per dot as the ejection-time distance decreases, and increases the ink ejection amount per dot as the ejection-time distance increases.

The voltage generation circuit 84 of the head 8 can generate a plurality of types of voltages. From among the plurality of types of voltages generated by the voltage generation circuit 84, one to be applied to the drive element 83 can be selected. That is, the voltage to be applied to the drive element 83 can be changed.

The amount of deformation of the drive element 83 changed depending on the voltage applied to the drive element 83. In accordance with the amount of deformation of the drive element 83, pressure applied to the supply flow path of the ink to the nozzles 81 changes. As the deformation amount of the drive element 83 increases, the pressure increases. Thus, by selecting a magnitude of the voltage to be applied to the drive element 83, the ink ejection amount from the head 8 (the ink ejection amount per dot) can be changed.

To help the control portion 10 adjust the ink ejection amount from the head 8, the storage portion 11 stores therein ink ejection amount data D5 in a non-volatile manner (see FIG. 8). The control portion 10 adjusts the ink ejection amount from the head 8 based on the ink ejection amount data D5.

An example of the ink ejection amount data D5 is shown in FIG. 14. The ink ejection amount data D5 is defined such that as the ejection-time distance decreases, the ink ejection amount per dot decreases. The ink ejection amount data D5 is also defined such that as the ejection-time distance increases, the ink ejection amount per dot increases.

In the ink ejection amount data D5 shown in FIG. 14, the ejection-time distance is classified into three categories. Here, there is no particular limitation to the number of categories of the ejection-time distances. Application voltages V1, V2, and V3 are voltages to be applied to the drive element 83, and have a relationship such that V1<V2<V3. An ejection-time distance W corresponding to the first voltage V1 is in a range such that 0 mm<W≤2 mm. An ejection-time distance W corresponding to the second voltage V2 is in a range such that 2 mm<W≤4 mm. An ejection-time distance W corresponding to the third voltage V3 is in a range such that 4 mm<W.

Ejection amounts a1, a2, and a3 are ink ejection amounts from the head 8. The ink ejection amount is a1 when the application voltage is the first voltage V1, a2 when the application voltage is the second voltage V2, and a3 when the application voltage is the third voltage V3. Since the ink ejection amount increases as the application voltage is larger, the following relationship holds: first ejection amount a1<second ejection amount a2<third ejection amount a3.

The control portion 10 selects the magnitude of the voltage to be applied to the drive element 83 based on the ink ejection amount data D5 and the ejection-time distance. That is, the control portion 10 sets the ink ejection amount from the head 8 (the ink ejection amount per dot).

According to the ink ejection amount data D5 shown in FIG. 14, when the ejection-time distance is 1 mm, the control portion 10 applies the voltage V1 to the drive element 83. That is, the control portion 10 sets the amount of ink to be ejected from the nozzles 81 per dot to the first ejection amount a1. When the ejection-time distance is 3 mm, the control portion 10 applies the voltage V2 to the drive element 83. That is, the control portion 10 sets the amount of ink to be ejected from the nozzles 81 per dot to the second ejection amount a2. When the ejection-time distance is 5 mm, the control portion 10 applies the voltage V3 to the drive element 83. That is, the control portion 10 sets the amount of ink to be ejected from the nozzles 81 per dot to the third ejection amount a3.

Other methods may be used to adjust the ink ejection amount from the head 8. As an example, ink ejection timing (frequency) of ejecting ink to one dot may be changed in accordance with the ejection-time distance. For example, when the ejection-time distance is such that 0 mm<W≤2 mm, the control portion 10 has ink ejected twice with respect to one dot. When the ejection-time distance is such that 2 mm<W≤4 mm, the control portion 10 has ink ejected three times with respect to one dot. When the ejection-time distance is such that 4 mm<W, the control portion 10 has ink ejected four times with respect to one dot. For high-speed ejection of ink, a frequency of the drive signal S1 may be made higher as the ejection-time distance is longer.

In the present embodiment, as described above, the printing device 100 includes the ink ejection device 1 and the plate devices 2. This configuration helps provide the printing device 100 which combines the advantage of digital printing and the advantage of analog printing. For example, a detailed image in a plurality of colors, a gradation image, etc. can be printed with the ink ejection device 1. On the other hand, a solid image, for example, in which density is liable to be reduced and color unevenness is likely to occur when printed by the ink ejection device 1, can be printed by the plate devices 2. As a result, it is possible to print, with respect to the fabric 7, a high-density, high-quality image with no color unevenness.

In the present embodiment, as described above, the ink ejection device 1 is attachable to and detachable from the printing device 100. With this configuration, the ink ejection device 1 can be easily attached, as necessary, to the printing device 100. When the ink ejection device 1 has become unnecessary, or when the plate device 2 needs to be attached, the ink ejection device 1 can be easily detached from the printing device 100.

It is also possible to detach the plate device 2 from the printing device 100 and attach the ink ejection device 1 to the position from which the plate device 2 has been detached. It is also possible to detach the ink ejection device 1 from the printing device 100 and attach the plate device 2 to the position from which the ink ejection device 1 has been detached. In this manner, it is possible to freely change the positions at which the ink ejection device 1 and the plate device 2 are respectively placed. For example, depending on an image to be printed on the fabric 7, the ink ejection device 1 can be placed on an upstream side of the plate device 2 in the Y-axis direction (the conveyance direction), or the ink ejection device 1 can be placed on a downstream side of the plate device 2 in the Y-axis direction (the conveyance direction).

Furthermore, since the single ink ejection device 1 can print an image in a plurality of colors, a plurality of plate devices 2 can be omitted just by attaching the single ink ejection device 1 to the printing device 100.

In the present embodiment, as described above, the conveyance device 3 is configured to be able to change the feeding amount by which to feed the fabric 7 in one feeding operation. With this configuration, it is possible to change the feeding amount by which to feed the fabric 7 in accordance with the resolution (the user-specified resolution) of printing performed by the ink ejection device 1. When the user has specified a high resolution, by feeding the fabric 7 by a reduced feeding amount, printing can be performed by the ink ejection device 1 with the user-specified resolution.

When the user has specified a low resolution, by feeding the fabric 7 by an increased feeding amount, productivity can be improved. When no printing is to be performed by the ink ejection device 1, by changing the feeding amount to an amount corresponding to the length of the screen plate 22 in the Y-axis direction, productivity can be further improved.

In the present embodiment, as described above, in the ink ejection device 1, which adopts the serial head system, the head 8 is movable in the Z-axis direction. Thus, the position of the head 8 in the Z-axis direction is adjustable. For example, the position of the head 8 in the Z-axis direction is adjustable in accordance with the type of an image to be printed on the fabric 7 and the type of the fabric 7. This contributes to further improvement of the image quality.

To print an image (for example, a two-dimensional code) that needs to be printed precisely on the fabric 7, the head 8 can be moved toward the fabric 7. To print an image that does not need to be printed precisely on the fabric 7, the head 8 can be moved away from the fabric 7.

It should be understood that the embodiments disclosed herein are merely illustrative in all respects, and should not be interpreted restrictively. The range of the present invention is shown not by the above descriptions of the embodiments but by the scope of claims for patent, and it is intended that all modifications within the meaning and range equivalent to the scope of claims for patent are included.

1. A printing device comprising:
a conveyance device which conveys a recording medium by performing a conveyance operation in which a feeding operation to feed the recording medium and suspension of the feeding operation are repeated;
a plate device which performs printing on the recording medium by using a plate; and
an ink ejection device which performs printing on the recording medium by ejecting ink onto the recording medium,
wherein
the ink ejection device includes
a head having a nozzle array including a plurality of nozzles arranged along a Y-axis direction parallel to a conveyance direction in which the recording medium is conveyed,
an X-axis moving mechanism which moves the head in an X-axis direction orthogonal to the Y-axis direction on a horizontal plane, and
a control portion which, when the feeding operation is suspended, performs scanning by controlling the X-axis moving mechanism to move the head in the X-axis direction, and which makes the head eject ink during the scanning,
the conveyance device performs the feeding operation once each time one event of the scanning is completed, and
the conveyance device is configured to be able to change a feeding amount by which to feed the recording medium in one event of the feeding operation.

2. The printing device according to claim 1,
wherein
the conveyance device changes the feeing amount in accordance with a resolution of printing performed by the ink ejection device.

3. The printing device according to claim 2,
wherein
the conveyance device reduces the feeding amount as the resolution is higher, and increases the feeding amount as the resolution is lower.

4. The printing device according to claim 1,
wherein
the feeding amount is an amount corresponding to (A÷(B÷C))+1 dot,
where
A represents a length of the nozzle array in the Y-axis direction,
B represents a resolution of printing performed by the ink ejection device, and
C represents a number of the nozzles per unit length of the nozzle array.

5. The printing device according to claim 1,
wherein,
when printing by the ink ejection device is not performed, the conveyance device changes the feeding amount to an amount corresponding to a length of the plate in the Y-axis direction.

6. The printing device according to claim 1,
wherein
the ink ejection device is attachable to and detachable from a conveyance line for the recording medium in the conveyance device.

7. The printing device according to claim 1,
wherein
the ink ejection device is fixed to a conveyance line for the recording medium in the conveyance device.

8. An ink ejection device which performs printing on the recording medium by ejecting ink onto the recording medium conveyed by the conveyance device of the printing device according to claim 1, the ink ejection device comprising:
a head having a nozzle array including a plurality of nozzles arranged along a Y-axis direction parallel to a conveyance direction in which the recording medium is conveyed;
an X-axis moving mechanism which moves the head in an X-axis direction orthogonal to the Y-axis direction on a horizontal plane; and
a control portion which, when the feeding operation is suspended, controls the X-axis moving mechanism to perform scanning in which the head is moved in the X-axis direction, and makes the head eject ink during the scanning.
